(19) United States
(12) Patent Application Publication
(10) Pub. No.: US 2018/0333615 A1
(43) Pub. Date: Nov. 22, 2018

(54) SPIKED BALL

(71) Applicant: Kessler Corporation, Los Angeles, CA (US)

(72) Inventors: Alexander Kessler, Los Angeles, CA (US); Brian Kessler, Los Angeles, CA (US)

(21) Appl. No.: 15/598,658

(22) Filed: May 18, 2017

(51) Int. Cl. A63B 41/08; F21V 33/00; F21V 3/02; F21V 23/02; F21V 23/04

(52) U.S. Cl. CPC A63B 41/08; F21V 33/008; F21V 23/04; F21V 23/02; F21V 3/02

(57) ABSTRACT

A spiked ball includes an inflatable ball having an outer surface and a series of protrusions on the outer surface. The protrusion each appear as a tear-dropped shape mass that includes a base having a relatively flat bottom adhered to the outer surface and a narrow tip extending away from the outer surface. The narrow tip may also appear as a curved tale.

The spikes provide a unique tactile feel and a surface for gripping that is different than other balls. The spikes also cause the ball to contact or “grab” the ground to create a unique bounce.

### TECHNICAL FIELD

The spiked ball relates to balls having an uneven surface or uneven surface layer, more particularly, balls have a non-smooth, tactile surface.

### BACKGROUND

Ball games are a popular form of play. Most conventional balls follow specific and standardized guidelines with dull and unexciting designs. The present invention proposes a novel design of the ball to enhance the pleasure of recreational ball games.

### SUMMARY

In one general aspect a spiked ball includes am inflatable ball having an outer surface and a series of protrusions on the outer surface. Embodiments may include one or more of the following features. For example the series of protrusions may include a tear-dropped shape mass that includes a base having a relatively flat bottom adhered to the outer surface and a narrow tip extending away from the outer surface. The narrow tip may be straight relative to a central axis of the ball or it may have a curve such that it appears more as a tail.

The base of each tear-dropped shaped mass may be in contact with the base of each adjacent tear-dropped shaped mass to completely cover the outer surface. Alternatively, the base of each tear-dropped shaped mass may be a discrete distance from the base of each adjacent tear-dropped shaped mass thereby exposing portions of the outer surface of the inflatable ball.

Each tear-dropped shaped mass deposited on the outer surface may be a polymer with elastic properties (elastomer), such as, for example, rubber, silicon rubber, polyisoprene or polybutadiene, polyisobutylene, etc. The inflatable ball may be made from thermoplastic polyurethane, thermoplastic rubber or polyvinyl chloride or other suitable materials.

The series of protrusions may appear as a layer of spikes covering the outer surface. The spikes may have different colors configured as a pattern or design.

The inflatable ball can have a fill valve. As another feature, there may be an illumination device inside the inflatable ball.

The inflatable ball may be spherical, a spheroid or any other suitable shape, such as, for example, an American style football.

In another general aspect, the spiked ball may include a first layer that includes a hollow sphere having a smooth outer surface and a second layer of more than one globule deposited or dropped onto the outer surface of the sphere. Each globule may appear as a tear-drop shaped mass having a relatively flat base and a narrow tip, the base of each tear-drop shaped mass adheres to the smooth outer surface with the narrow tip extending away from the outer surface.

Embodiments may include one or more of the above or following features. For example, the second layer may be a continuous layer completely covering the first layer thereby adding additional structural integrity. There may also be a lighting device inside the first layer.

In still another embodiment, a spiked globe may be used in a decorative lamp, that includes a translucent or transparent sphere having a relatively smooth outer surface and more than one tear-drop shaped spike attached to the outer surface, each spike having a relatively flat base and a narrow tip extending away from the outer surface, an illumination device or light source inside the sphere and an electrical lighting circuit having a power source and a switch, the lighting circuit being electrically connected to the light source to turn it on and off.

Embodiments may include one or more of the above or following features. For example, a base can be attached to the sphere. In addition, the lighting circuit may be enclosed within the base.

### BRIEF DESCRIPTION OF THE DRAWINGS

The following drawings show some of the exemplary embodiments of the present invention:

FIG. 1 shows a spiked ball according to the present invention;

FIG. 2 shows a cross-section perspective view of the ball in FIG. 1;

FIG. 3 shows the layers of the ball of FIG. 1;

FIG. 4 shows a portion of a cross-section of the ball in FIG. 1;

FIG. 5 shows a second embodiment of the spiked ball according to the present invention;

FIG. 6 shows a third embodiment of the spiked ball according to the present invention;

FIG. 7 shows a cross-sectional view of a fourth embodiment of a spiked globe used as a lamp; and

FIG. 8 shows a lighting circuit for the lamp shown in FIG. 7.

### DETAILED DESCRIPTION

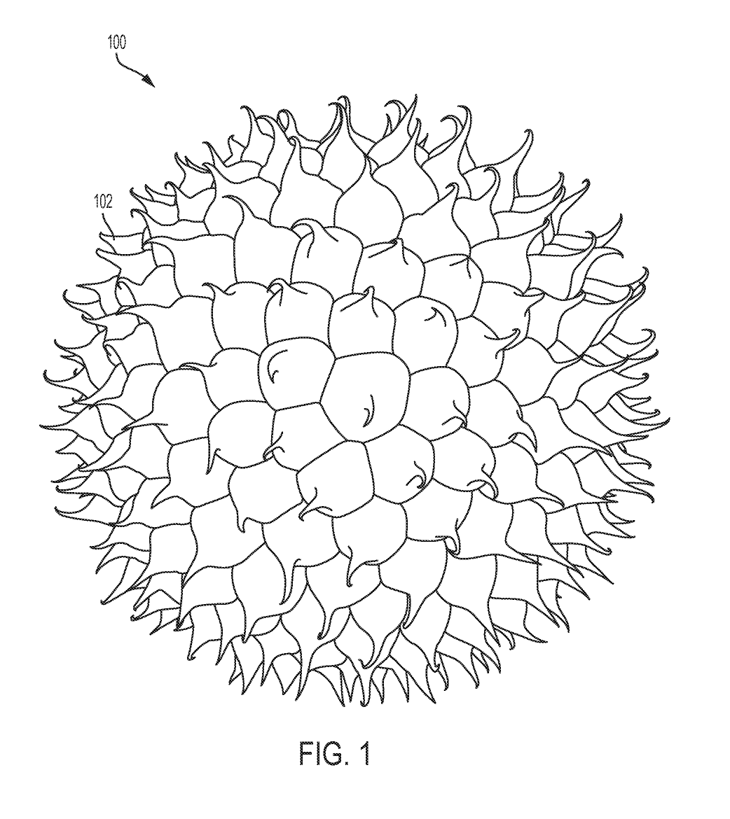

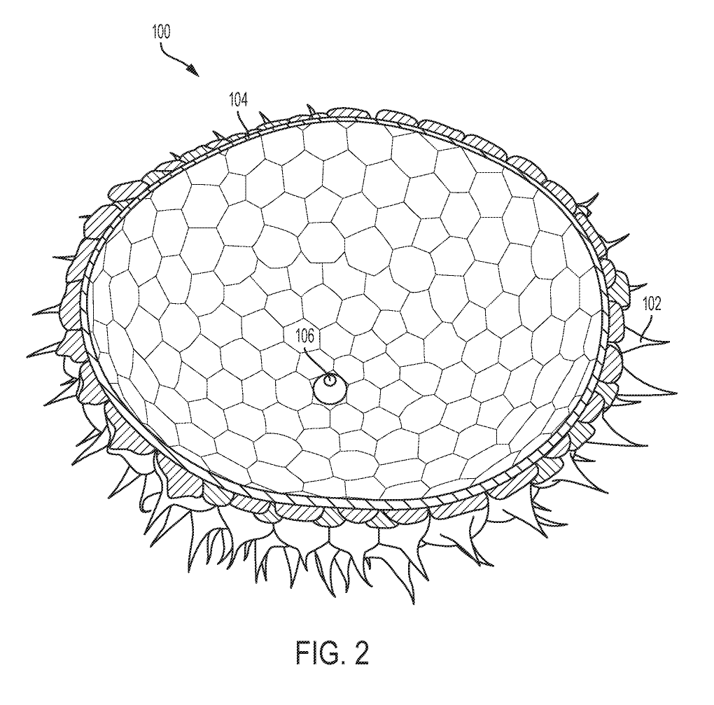

Referring to FIGS. 1-2, a spiked ball 100 includes a series of spikes 102 covering an inner pressurized ball 104. Hundreds of spikes 102 made of silicon rubber or other elastomers are positioned on the inner ball 104 which is made of plastic or other rubber hybrids, such as, for example, thermoplastic polyurethane, thermoplastic rubber or polyvinyl chloride or other suitable materials. The result is a play ball 100 that does not have a heavy, dangerous hard core and creates a ball 100 that can be used in unique ways that no other ball can do.

The spikes 102 can be made of a softer elastomer such with a high degree of elasticity. This elasticity of the protruding spikes 102 gives the ball 100 a unique tactile feel and provides a surface for gripping that is different than any other ball. The protruding spikes 102 cause the ball 100 to contact or “grab” the ground to create a unique bounce. The spikes 102 may be straight or curved relative to a central axis of the ball 100.

The inner pressurized ball 104 can be made of any inflatable ball structure but typically would not be a balloon or other material that could puncture easily. The inner ball 104 should maintain its own integral structure and pressure to be a product that maintains durability and long life. However, in other embodiments the spikes 102 are a complete layer that provides additional structural integrity.

FIG. 2 is a cut-away or cross section of the ball 100. A fill valve 106 is used to pressurize the ball 100. The ball 104 is made of a transparent material. Thus, the bottom or base 110 of the spikes 102 are visible from the inside of the ball 104. The spikes may be fairly viscous, fluid-like globules when deposited on the ball. Thus, depending on the proximity and pattern of application of the spikes on the ball, the bottom of the spikes can take on random non-circular shapes as the globules settle onto the surface of the ball 104.

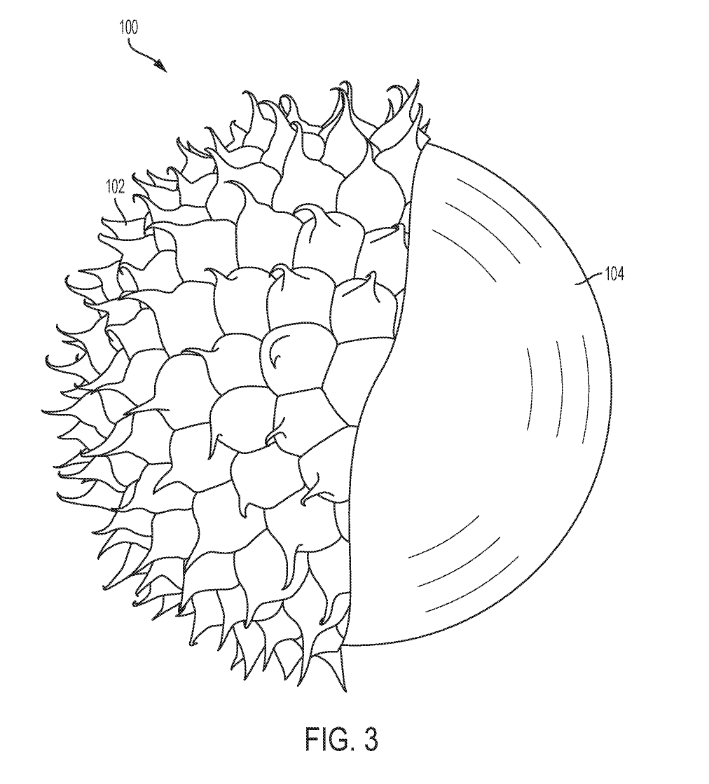

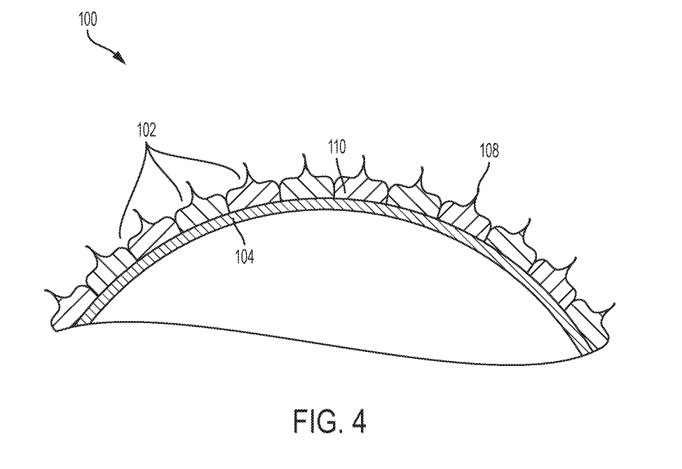

FIGS. 3 and 4 show an embodiment where the spikes are applied in a continuous layer so as to essentially cover the surface of the inner ball 104. As shown in the more detailed view of FIG. 4, the spikes 102 may have a tear-dropped shape with a flat bottom or base 110 adhered to the inner ball 104 and a tail or tip 108 extending away from the center of the spiked ball 100. The base 110 of each tear-dropped mass or spike 102 is in contact with and essentially bonded to the base 110 of each adjacent spike. Thus, the inner ball 104 may not be visible and the continuous bonding of adjacent spikes may add some additional structural integrity.

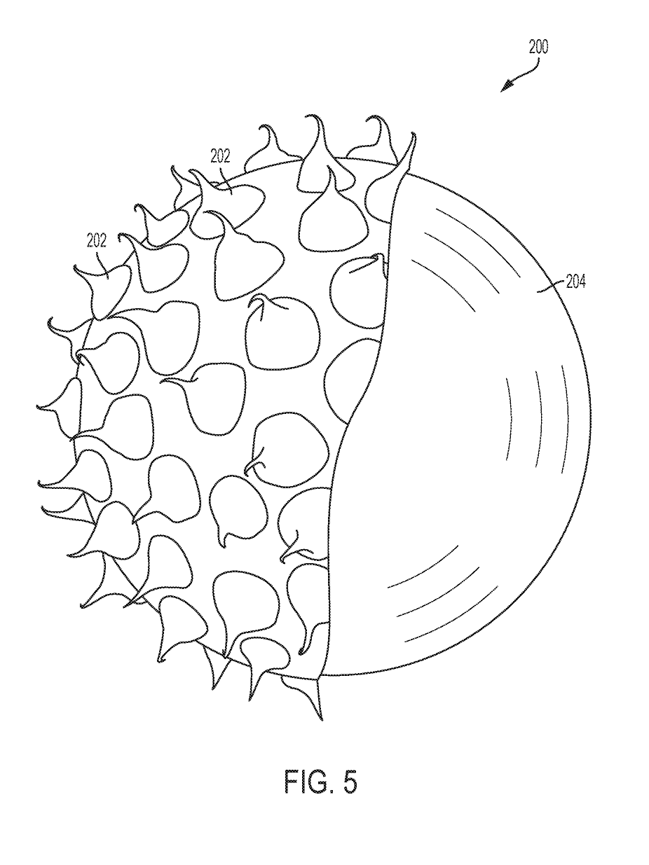

FIG. 5 shows a second embodiment of the ball 200 where a discrete distance is maintained between each spike 202 on an inner pressurized ball 204. Thus, the surface of the ball 204 is visible between the spikes. As shown, the tail of each spike 202 may be curved relative to a central axis of the ball 204.

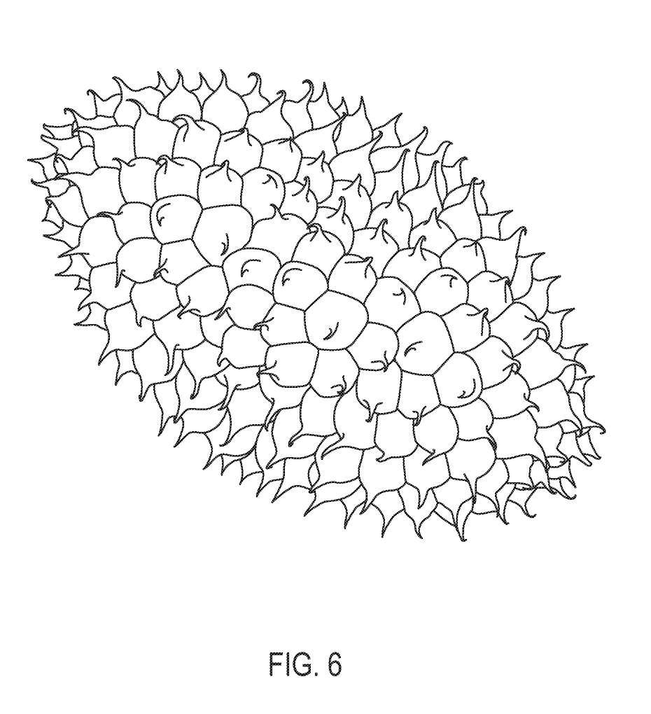

FIG. 6 shows a third embodiment of the spiked ball 300 with a ball that has a shape similar to an American football. Once again, the spikes may be a discrete distance from each other on the pressurized ball 304. The third embodiment is just another example of potential outer shapes which are essentially unlimited.

The manufacturing technique to make the spiked ball can incorporate an automatic or semi-automatic process that applies silicon spikes to the round ball. A “drop” process may be used to produce the spiked ball. In the drop process, a highly viscous elastomer globule is deposited onto the outer surface. The high viscosity globule creates the tail-shaped appearance as it leaves a dispensing device and is deposited onto the ball. The ball is then continuously rotated to deposit each of the spikes in continuous rows or layers as desired.

In addition to a unique tactile surface the spikes allow for a unique visual appearance. Unique patterns can be created using a pixel approach to design. For example, the ball can have stripes, X patterns or triangles. With computer assistance, the spikes may appear as faces, words or other designs may be created.

The ball can be of any size based on the size of the inner ball. Smaller balls may have a solid inner core, but hollow cores are preferred with balls greater than 2 inches in diameter. Otherwise, the additional weight could cause a potentially dangerous impact with a person or could cause damage to another object.

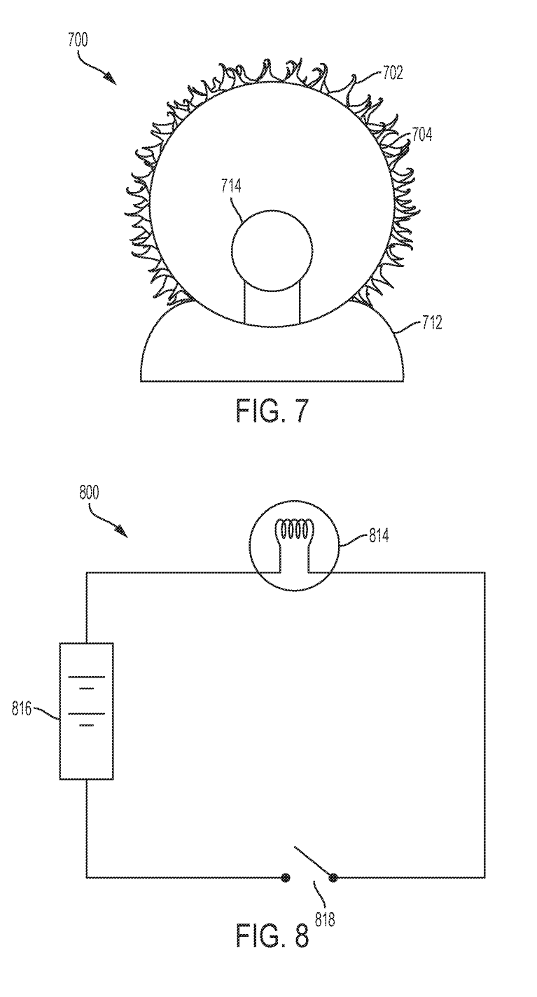

FIG. 7, the spiked design can be used for a lamp 700, such as, for example, a night light. The lamp 700 includes a base 712, a globe 704 covered with spikes 702, and a light source 714 inside the globe. The light source may be incandescent, LED or other types of illumination. For a night light application, typically the light source 714 would be low wattage.

FIG. 8 shows an illumination or electrical lighting circuit 800 for the lamp 700. The circuit 800 includes a battery 816 connected to the light source 814 by a switch. The circuit 800 uses a battery 816, however, other sources of power may be used such as a plug into 112 volt alternating current house power with a voltage reduction transformer and a rectifier circuit.

The electrical (illumination) circuit may be in the base 712 of the lamp. In another embodiment, an electrical power circuit is enclosed within an inflated spiked ball. The power circuit has a motion sensor such that the light source is only illuminated when the ball receives an impact or is otherwise moved or in motion. In this embodiment, the circuitry can be made extremely durable so that the ball can be bounced or thrown without damage.

Numerous characteristics and advantages of the present invention have been set forth in the foregoing description, together with details of the structure and function of the invention. However, the disclosure is illustrative only, and changes may be made in details, especially in matters of shape, size, and arrangement or addition of materials that are understood to be within the scope of the invention.

1. A spiked ball, comprising:
an inflatable ball having an outer surface; and
a series of protrusions on the outer surface.

2. The spiked ball of claim 1, wherein the series of protrusions comprise a tear-dropped shaped mass that includes a base having a relatively flat bottom adhered to the outer surface and a narrow tip extending away from the outer surface.

3. The spiked ball of claim 2, wherein the base of each tear-dropped shaped mass is in contact with the base of each adjacent tear-dropped shaped mass.

4. The spiked ball of claim 3, wherein the contact between the base of each tear-dropped shaped comprises an outer layer completely covering the outer surface of the ball.

5. The spiked ball 2, wherein the base of each tear-dropped shaped mass is a discrete distance from the base of each adjacent tear-dropped shaped mass.

6. The spiked ball of claim 2, wherein each tear-dropped shaped mass comprises an elastomer deposited on the outer surface.

7. The spiked ball of claim 6, wherein the elastomer comprises silicon rubber.

8. The spiked ball of claim 1, wherein the series of protrusions comprises a layer of spikes covering the outer surface.

9. The spiked ball of claim 1, wherein the inflatable ball comprises thermoplastic polyurethane, thermoplastic rubber or polyvinyl chloride.

10. The spiked ball of claim 1, wherein the protusions comprise different colors configured as a pattern or design.

11. The spiked ball of claim 1, wherein the inflatable ball comprises a fill valve.

12. The spiked ball of claim 1, wherein the inflatable ball comprises a spherical ball.

13. The spiked ball of claim 1, wherein the inflatable ball comprises a spheroid shape.

14. The spiked ball of claim 1, wherein the series of protrusions each comprise a tear-dropped shape mass that includes a base having a relatively flat bottom attached to the outer surface and a narrow tail extending away from the outer surface wherein the tail is curved relative to a central axis of the ball.

15. A spiked ball, comprising:
a first layer that includes a hollow sphere having a relatively smooth outer surface; and
a second layer of more than one tear-drop shaped mass having a relatively flat base and a narrow tip, the base of each tear-drop shaped mass adhered to the outer surface with the narrow tip extending away from the outer surface.

16. The spiked ball of claim 15, wherein the second layer comprises a continuous layer completely covering the first layer thereby adding additional structural integrity.

17. The spiked ball of claim 15, wherein the second layer comprises a series of elastomer globules dropped onto the outer surface.

18. The spiked ball of claim 15, wherein the narrow tip comprises a tail having a curvature relative to a central radius of the sphere.

19. A lamp, comprising:
a translucent or transparent sphere having a relatively smooth outer surface and more than one tear-drop shaped spike attached to the outer surface, each spike having a relatively flat base and a narrow tip extending away from the outer surface;
an illumination device inside the sphere; and
an electrical lighting circuit having a power source and a switch, the lighting circuit being electrically connected to the illumination device to turn the illumination device on and off.

20. The lamp of claim 19, further comprising a base attached to the sphere, wherein the lighting circuit is enclosed within the base.
